(19) United States
(12) Patent Application Publication
(10) Pub. No.: US 2006/0204919 A1
(43) Pub. Date: Sep. 14, 2006

(54) Orthodontic wire and method for making same

(76) Inventor: Pol Jean-Marie Robert Thiry, CHARLEVILLE MEZIERES (FR)

Correspondence Address: EGBERT LAW OFFICES, 412 MAIN STREET, 7TH FLOOR, HOUSTON, TX, 77002, US

(21) Appl. No.: 10/537,652

(22) PCT Filed: Dec. 17, 2003
(86) PCT No.: PCT/FR03/50183

§ 371 Date: Feb. 27, 2006

(30) Foreign Application Priority Data
Dec. 19, 2002 (FR) 02 1625

(51) Int. Cl. A61C 3/00

(52) U.S. Cl. 433/20

(57) ABSTRACT

The invention concerns an orthodontic wire, combined with attachments bonded on the teeth, to correct position anomalies thereof, made of a material having high mechanical performances and a very low friction coefficient on said attachments. Said material is defined by a base structure made of a titanium-molybdenum alloy comprising, in its outer surface layer; titanium nitrides of type TiN, Ti₂N, free of titanium oxide.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention concerns a metallic wire that can be used in particular in the medical sector and more specifically in orthodontics, to correct teeth position anomalies.

### BACKGROUND OF THE INVENTION

In a simplified manner, the correction of the teeth position anomalies is made in most cases by submitting the tooth or teeth in question to a force variable in intensity and in direction for a specified time. These forces are transmitted to the teeth through an orthodontic wire, connected, through ligatures, to attachments bonded on the teeth in question.

In order to achieve optimal efficiency, the orthodontic wire should have high mechanical characteristics, and should, in particular, have:
a wide elastic range permitting to impart to it a maximal activation without permanent deformation, the intensity forces being as continuous as possible,
low rigidity permitting it to impart slight forces with a sufficient cross-section to control dental displacement,
sufficient malleability and resistance to breaking permitting to fold it or shape it easily,
welding properties,
satisfactory resistance to corrosion,
biocompatibility.

In the techniques based on a multi-attachment system, dental displacement is performed by sliding the attachments on the orthodontic wire that guides them. The friction forces play a role in all forms of sliding.

According to studies carried out by specialists, it is necessary, using the modern techniques, to exert a force within the range from 0.7 to 1 N on the teeth in order to manage to displace them by 0.5 mm over a week; nevertheless, just a few hundredths of a Newton are actually used to produce this physiologic movement of the teeth. The difference is attributed to the friction of the orthodontic wire in the attachment.

In order to optimize dental movements and tissue response, it is therefore essential to understand and reduce the friction forces between attachment and orthodontic wire.

According to other studies carried out by specialists, dental displacement along an orthodontic wire, due to sliding mechanics, consists of a succession of inclinations, followed by straightening operations by small increments. The movement therefore depends more on the static friction than on the kinetic friction.

Numerous studies have been carried out regarding the friction parameters between the attachments and the wire, taking into consideration the physical parameters of the elements used as well as the biological parameters of the application, given below:
the characteristics connected with the attachments, in particular the constituent materials, the width of the grooves, their shape, their superficial condition,
the characteristics of the ligatures that maintain the orthodontic wire in the groove of the attachment such as the type of materials, the shapes, the superficial condition and the tightening forces,
the characteristics of the wires with respect to the type of materials, their size, the shape of their cross-section their rigidity,
the three-dimensional relationship between the wire and the attachments, such as annulment, torque, force-applying point,
biological parameters, in particular saliva, and plaque.

The results of these studies have taken into consideration in the range of solutions currently provided to the practitioners in terms of type of attachments, orthodontic wires, and ligatures.

Thus, regardless of their round or rectangular cross-section, of the more or less considerable surface of the latter, or of the mono- or multi-strand characteristics, four wire categories are currently known, based on different materials that can be used in orthodontics.

One of these categories concerns wires made of austenitic stainless steel, having variable nuances and heat treatments, but that are all characterized by high resistance to breaking and elastic limit stress, high elasticity modulus, low friction coefficient on the attachments.

Although the first two properties mentioned above represent factors of no great significance in orthodontics, this type of wire is regarded as a reference in terms of friction coefficient.

The mechanical properties of this type of wires, detected on samples, have led to the following mean values:
Elastic limit in flexion: Ys=1.257 Gpa,
Elastic limit in traction: Ys=1.53 Gpa,
Elasticity modulus in flexion: E=171 Gpa,
Elasticity modulus in traction: −E=178 Gpa.

All other category of wires is based on a nickel-titanium alloy, in which the nickel stabilizes the α phase of the titanium that can be transformed into martensite under the action of mechanical or thermal strains.

With a composition of 52% nickel, 45% titanium and 3% cobalt, this alloy has, after strain hardening, rubbery properties. Its elasticity modulus is very low, its traction curve is very different from the one of a classic alloy, and the wire deforms elastically of breaks; thus, the possible types of curvature are limited and this alloy is solely marketed in the form of preformed orthodontic wires.

The low malleability, the resistance to corrosion that is lower than that of steel, the difficult welding, the relatively high friction of this alloy therefore limit its use in orthodontics.

A third category of wires concerns those made of a titanium-molybdenum alloy.

The latter have been used in orthodontics since quite recently and have contributed to develop in a favorable way the treatments in terms of results, rapidity and tissue efficiency. They are commercially available and are commonly called “beta-titanium”.

Titanium-molybdenum was introduced in the orthodontic world by Burstone for the Ormco company after elaboration made by metallurgist Goldberg of the Institute of Materials Science of Connecticut in 1979. Its composition is as follows:
77.8% titanium;
11.3% molybdenum;
6.6% zirconium;
4.3% tin.

Titanium has been used in metallurgy since 1952, and in 1960 a particular form of high temperature titanium alloy was developed. Titanium can practically crystallize according to two systems:
compact hexagonal system (phase α);
centered cubic system (phase α).

The transformation from phase α stable under cold conditions, into phase a stable under warm conditions, is performed at about 885° C. At room temperature, titanium has therefore a compact hexagonal structure. Since 1960, metallurgists have managed to stabilize the centered cubic structure (phase α) at room temperature thanks to the addition of molybdenum. This permits to obtain the titanium-molybdenum alloy (beta-titanium) having an elastic limit compatible with orthodontic use.

The mechanical properties of titanium-molybdenum published and detected on samples have the following values:
Elastic limit in flexion: Ys 0.72 Gpa to 1.17 Gpa (1.359 mean Gpa detected)
Elastic limits in traction: Ys 0.45 Gpa to 1.38 Gpa (0.90 mean Gpa detected)
Elasticity modulus in flexion: E=72 Gpa (72 mean Gpa detected)
Elasticity modulus in traction: E=64.8 GPa (63 mean Gpa detected)

Young's modulus measured for wires made of titanium-molybdenum corresponds to one half of that detected for wires made of stainless steel, yet the elastic limit is approximately identical.

On the other hand, the use of titanium-molybdenum alloy for producing orthodontic wires has some advantages with respect to the use of stainless steel.

In particular, the intensities of the developed forces are lower than those developed by stainless steel, and titanium-molybdenum permits an elastic deformation of greater amplitude. For this reason, the force returned by the wire remains smaller, more constant and acts for a longer time.

The working field of titanium-molybdenum corresponds to 1.6 times that of steel. Thus, with respect to stainless steel, wires made of titanium-molybdenum can be bent over a distance that is twice as great, without permanent deformation. This permits a greater field of action, both in the initial alignment of the teeth and for wires used at the level of finishing. This translates into an elastic deformation of great amplitude, still developing forces that are moderate and more durable.

Because of its low rigidity (rigidity coefficient of 0.42 with respect to stainless steel), titanium-molybdenum alloy can be used for producing wires having considerable cross-sections, at a much earlier stage of orthodontic treatment; this permits a more considerable filling of the grooves of the attachments and therefore a better three-dimensional control of the teeth carrying the attachments.

Furthermore, titanium-molybdenum can be welded to itself, by electric welding, without adding metal. It has a good resistance to corrosion and is biocompatible. The wires made of titanium-molybdenum (beta-titanium) have a unique equilibrium of low rigidity, high maximal flexion, of certain malleability, making them particularly reliable in numerous forms of orthodontic treatments.

Nevertheless, the titanium-molybdenum alloy has some disadvantages, of which the most important one consists in that it generates more intense friction forces than stainless steel, which is a hindrance to dental displacement in the sliding mechanics, for example during canine retractions or closing of gaps.

In order to cope with this disadvantage, wires made of low friction titanium-molybdenum alloy, commonly called “beta-titanium low friction” are currently marketed.

Those are wires of the same internal composition as the titanium-molybdenum wires mentioned above but having undergone a superficial treatment permitting to diminish the friction coefficient of the wire on the attachments. However, our tests have shown that the interesting characteristics of the basic material are well preserved, but that the evolution is not very significant as far as improvement of friction coefficient on the attachments is concerned.

### BRIEF SUMMARY OF THE INVENTION

Thus, as far as the orthodontic wires are concerned, there has been, until now, no ideal solution associating high mechanical performances and very low friction coefficient on the attachments.

This invention therefore aims at fining this gap, by providing a metallic wire that can be used in orthodontics, in association with attachments bonded on the teeth, to correct position anomalies thereof, made of a material having high mechanical performances and very low friction coefficient on said attachments.

### DETAILED DESCRIPTION OF THE INVENTION

According to this invention, such a wire is characterized in that the material of which it is composed is defined by a basic structure made of a titanium-molybdenum alloy comprising, in its outer surface layer, titanium nitrides of the type TiN, Ti₂N, free of titanium oxide.

The invention also aims at providing a method for making the material defined by a basic structure made of a titanium-molybdenum alloy comprising, in its outer surface layer, titanium nitrides of the type TiN, Ti₂N, free of titanium oxide.

Such a method mainly consists in performing a treatment of superficial implantation of N⁺ and N⁺⁺ ions in the external superficial layer of the titanium-molybdenum alloy, working in an enclosure under vacuum, at a temperature lower than 450° C. This treatment permits to preserve the classic mechanical properties of the titanium-molybdenum alloy, yet improving considerably its friction coefficient.

It permits to achieve titanium nitrides (TiN and Ti₂N) on the surface and within several microns in depth. Since the implantation of ions is made in the absence of oxygen, the creation of titanium oxides is avoided, the latter being able to deteriorate the friction coefficient and limit nitriding.

According to another feature of the ion implantation method, the treatment is carried out in two consecutive phases, performing first a depassivation and increasing the temperature by non-reactive cold plasma (introducing an inert gas such as for example argon) for about 45 minutes, then performing a nitriding also achieved by cold plasma, introducing a mixture of inert gases, for example argon and nitrogen, for about 200 minutes.

The whole treatment is performed at a temperature lower than 450° C.

According to an additional feature of this method, the proportions of argon and nitrogen used during the nitriding phase should be adapted to the volume of the enclosure, but should be such that there is enough nitrogen for same to be implanted and enough argon to dissociate the nitrogen.

Furthermore, in this method, according to another feature, the superficial treatment described above is completed by a slow cooling phase.

Such a treatment permits on the one hand to obtain advantageously a wire in which all mechanical characteristics so to speak inherent to the classic titanium-molybdenum alloy, which are regarded as the best in the current state of the art in orthodontic are preserved.

Thus, the following values were measured, relating to mechanical characteristics of wires according to the invention made of a material defined by a basic structure made of a titanium-molybdenum alloy comprising, in its outer surface layer, titanium nitrides of the type TiN, Ti₂N) free of titanium oxide, after treatment:
Elastic limit in flexion: 1.381 Gpa.
Elastic limit in flexion: 0.999 Gpa
Elasticity modulus in flexion: 88 Gpa
Elasticity module in traction: 73 Gpa

On the other hand, the material according to this invention permits, in addition, to improve substantially the friction of the orthodontic wire on the attachments to make it equivalent, and even superior to that of stainless steel, regarded by all users as the reference in this field.

Thus, in order to characterize and compare the intensity of the motion in the applications taken into consideration, the joints between the orthodontic wires and the attachments are tested by means of a reciprocating-movement method, in which an attachment is bonded on a metallic pivot. The wire applied on this attachment is maintained by an elastomeric ligature; the whole is lubricated by artificial saliva. The testing machine ensures the traction of the wire alternately based on a 5-millimeter fixed travel. This reciprocating movement is repeated more than 100 times per test.

The mean amplitude for the stress measured by the test machine, at each movement, comparatively characterizes the intensity of the static motion between the wire and the attachment.

The measured comparative values, according to the different types of tested wires are as follows:
Stainless steel: 6.49
Titanium-molybdenum alloy: 15.81
Titanium-molybdenum alloy “low friction”: 11.60
Nitrided titanium-molybdenum alloy, according to the invention: 2.90

Therefore, due to the considerable improvement of static and dynamic friction coefficients obtained by using a wire according to the invention, preserving all valuable mechanical properties of wires made of classic titanium-molybdenum alloy, an extension of its use in orthodontics can be expected.

1. Orthodontic wire, in association with attachments bonded on teeth, to correct position anomalies thereof, comprising:
a material having high mechanical performances and very low friction coefficient on said attachments, said material being defined by a basic structure comprised of a titanium-molybdenum alloy comprising, in an outer surface layer thereof, titanium nitrides of the type TiN, Ti₂N, free of titanium oxide.

2. Method for making a metallic wire according to claim 1, said method comprising the steps of:
forming titanium nitrides of type TiN, Ti₂N in an external superficial layer of a titanium-molybdenum alloy,
performing a treatment of superficial implantation of N⁺ and N⁺⁺ ions, and
working in an enclosure under vacuum, at a temperature lower than 450° C.

3. Method according to claim 2, wherein said step of performing the treatment of superficial ionic implantation is performed in two consecutive phases.

4. Method according to claim 3, further comprising the steps of:
first submitting titanium-molybdenum alloy to a phase of depassivation by non-reactive cold plasma by introducing an inert gas yet progressively increasing the temperature, then
submitting to a phase of nitriding by cold plasma by introducing a mixture of an inert gas and nitrogen.

5. Method according to claim 4, wherein said step of performing treatment during the two phases of the treatment of superficial implantation of N⁺ and N⁺⁺ ions, said inert gas is comprised of argon.

6. Method according to claim 4, wherein the forming nitrides step further comprises:
using proportions of inert gas and nitrogen that are used are adapted to volume of an enclosure in which said step takes place, and
comprising enough nitrogen to permit implantation thereof and enough argon to dissociate the nitrogen.

7. Method according to claim 4, further comprising:
submitting a titanium-molybdenum alloy to the depassivation phase for about 45 minutes, then to the nitriding phase for about 200 minutes.

8. Method according to claim 2, said step of performing treatment of superficial ionic implantation of the titanium-molybdenum alloy is completed by a slow cooling phase.
